(19) United States
(12) Patent Application Publication
(10) Pub. No.: US 2020/0016612 A1
(43) Pub. Date: Jan. 16, 2020

(54) Sprinkler

(71) Applicant: Ruey Ryh Enterprise Co., Ltd., Sioushuei Township Changhua County (TW)

(72) Inventor: Chen-Fu Hung, Sioushuei Township (TW)

(21) Appl. No.: 16/510,997

(22) Filed: Jul. 15, 2019

(30) Foreign Application Priority Data
Jul. 16, 2018 (TW) 107209597

(51) Int. Cl. B05B 1/16

(52) U.S. Cl. CPC B05B 1/1663

(57) ABSTRACT

A sprinkler comprises a water outlet tube and an annular adjusting element. The water outlet tube comprises a positioning and stopping portion and a mounting section with a position-limiting guide block. The position-limiting guide block comprises a water outlet opening communicating with the interior of the water outlet tube. The adjusting element comprises a pivot hole that allows the adjusting element to rotate about and along the mounting section. The pivot hole comprises a position-limiting space for accommodating the position-limiting guide block in a pivotable manner, in order for the position-limiting guide block to limit back-and-forth rotation of the adjusting element. The position-limiting space comprises a through hole and a water-blocking area. The adjusting element can be rotated in one direction to align the through hole with the water outlet opening and in the opposite direction to block the water outlet opening with the water-blocking area.

### TECHNICAL FIELD

The present invention relates to a sprinkler and more particularly to an improved sprinkler structure that allows the number of its effective water outlet openings and the number of its blocked water outlet openings to be easily adjusted according to the size of the area to be sprinkled, thereby not only preventing a wasteful use of water, but also ensuring that a proper amount of water will be sprayed over the area to meet the water demand of the plants in the area optimally.

### BACKGROUND OF THE INVENTION

Due to the improvement of the standard of living, people nowadays enjoy, and have certain requirements for, the lawns, flowers, and so on in their own gardens and in public places such as the atriums of public buildings, parks, athletic fields, and the venues of public events. It is important, therefore, to have irrigation sprinklers adapted to horticultural environments of different sizes. However, while the market is supplied with a great variety of sprinklers, none of them allows its user to adjust the number of effective or blocked water outlet openings with ease.

For example, the sprinklers disclosed in Taiwan Patent Nos. M494479, 1313192, and 1266604 are structurally complicated, do not allow ready adjustment of the number of effective water outlet openings according to the size of the area to be sprinkled, and hence may lead to either a wasteful use of water or failure to spray a large area with the required amount of water. To overcome the aforesaid drawbacks, sprinklers of different specifications must be bought and installed. The conventional sprinklers, therefore, are lacking in terms of convenience and market competitiveness.

### BRIEF SUMMARY OF THE INVENTION

In view of and motivated by the drawbacks of the conventional sprinklers in structural design and use, the inventor of the present invention started to redesign the sprinkler structure by incorporating years of practical experience into the redesigning process, and after a comprehensive research and repeated corrections, the present invention was finally obtained.

The primary objective of the present invention is to provide an improved sprinkler structure in which: a water outlet tube is provided with a mounting section at one end; the mounting section includes a positioning and stopping portion, a position-limiting guide block, and a plurality of water outlet openings; each water outlet opening is mounted with an adjusting element that has a pivot hole, a position-limiting space, a through hole, and a water-blocking area; and the position-limiting guide block is received in the position-limiting spaces of the adjusting elements in such a way that the adjusting elements can be rotated back and forth about and along the mounting section through the pivot holes to displace the through holes and the water-blocking areas. When the through hole of any of the adjusting elements is aligned with the corresponding water outlet opening, the corresponding outlet opening is rendered effective and allows passage of water. When the water-blocking area of any of the adjusting elements is aligned with the corresponding water outlet opening, on the other hand, the corresponding water outlet opening is blocked and does not allow passage of water. Thus, the number of the effective or blocked water outlet openings of the sprinkler can be increased or decreased as needed to provide flexibility and variability in use. For example, the number of the effective or blocked water outlet openings can be easily adjusted according to the size of the area to be sprinkled, in order to spray a proper amount of water over the area to not only prevent a wasteful use of water, but also ensure that the water demand of the plants in the area is perfectly met.

### BRIEF DESCRIPTION OF THE SEVERAL VIEWS OF THE DRAWINGS

FIG. 1 is an exploded perspective view of an embodiment of the present invention;

FIG. 2 is an exploded perspective view of one of the adjusting elements in FIG. 1;

FIG. 3 is an assembled sectional view of the embodiment in FIG. 1, showing the water outlet opening in an effective state (i.e., water output state);

FIG. 4 is a side elevation view of the embodiment in FIG. 1, showing that each water outlet opening of the water outlet tube is in communication with the through hole of the corresponding adjusting element and therefore in an effective state (i.e., water output state);

FIG. 5 is similar to FIG. 3 except that the water outlet opening is in a blocked state;

FIG. 6 is a side elevation view of the embodiment in FIG. 1, showing that one of the water outlet openings of the water outlet tube is aligned with the water-blocking area of the corresponding adjusting element and therefore in a blocked state; and

FIG. 7 is a side elevation view of the embodiment in FIG. 1, showing that each water outlet opening of the water outlet tube is aligned with the water-blocking area of the corresponding adjusting element and therefore in a blocked state.

### DETAILED DESCRIPTION OF THE INVENTION

To enable a better understanding of the structural features and effects of the present invention, a detailed description of the best mode of implementing the invention is given below with reference to the accompanying drawings.

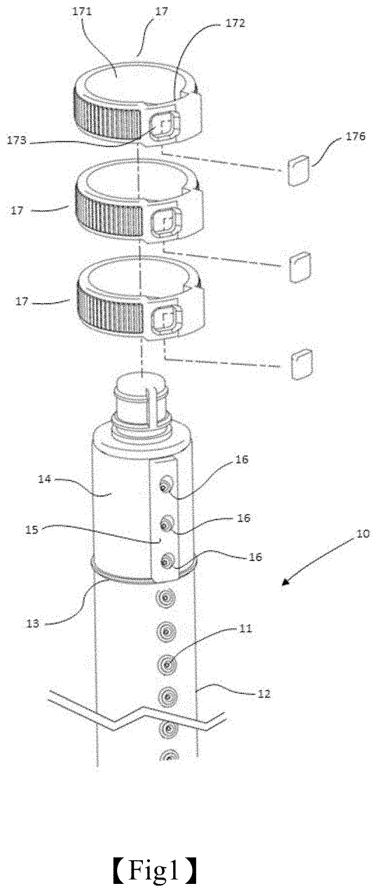

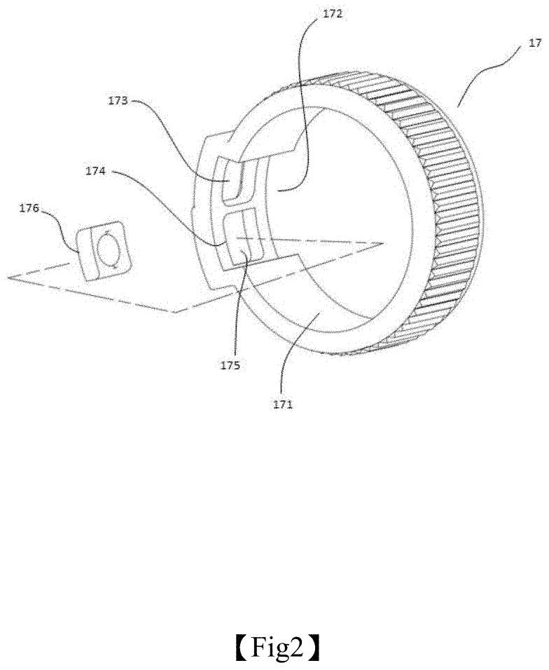

Referring to FIG. 1 and FIG. 2, the sprinkler 10 includes a water outlet tube 12 having a plurality of water outlet holes 11. The water outlet tube 12 is provided with a positioning and stopping portion 13 on one or two lateral sides. Here, the positioning and stopping portion 13 protrudes from the outer surface of the water outlet tube 12 and surrounds the outer periphery of the water outlet tube 12. A mounting section 14 is provided on one side of the positioning and stopping portion 13 and is protrudingly provided with a position-limiting guide block 15 on one side. The position-limiting guide block 15 has an elongated and narrow configuration, corresponds in position to the water outlet holes 11, and is provided with two or more water outlet openings 16 on one side, wherein the water outlet openings 16 are in alignment with the water outlet holes 11. The water outlet openings 16 are in communication with the interior of the water outlet tube 12 so that water can be output through the water outlet openings 16. The sprinkler 10 also includes one or more adjusting elements 17 corresponding in number to the water outlet openings 16 of the mounting section 14 in order to be mounted around the water outlet openings 16 respectively. Each adjusting element 17 has an annular shape and forms a pivot hole 171 that allows the adjusting element 17 to be rotated about and along the mounting section 14. As can be clearly seen in FIG. 2, the pivot hole 171 is protrudingly provided with a position-limiting space 172 on one side to accommodate the position-limiting guide block 15. The position-limiting space 172 is larger than the position-limiting guide block 15 so as to receive, and be pivotable with respect to, the position-limiting guide block 15, in order for the position-limiting guide block 15 to limit back-and-forth rotation of the adjusting element 17. Also provided in the position-limiting space 172 are a through hole 173 and a water-blocking area 174, the two of which are spaced apart from each other and correspond in position to the water outlet openings 16. The water-blocking area 174 includes a groove 175 and a rubber water-blocking pad 176 fitted in the groove 175.

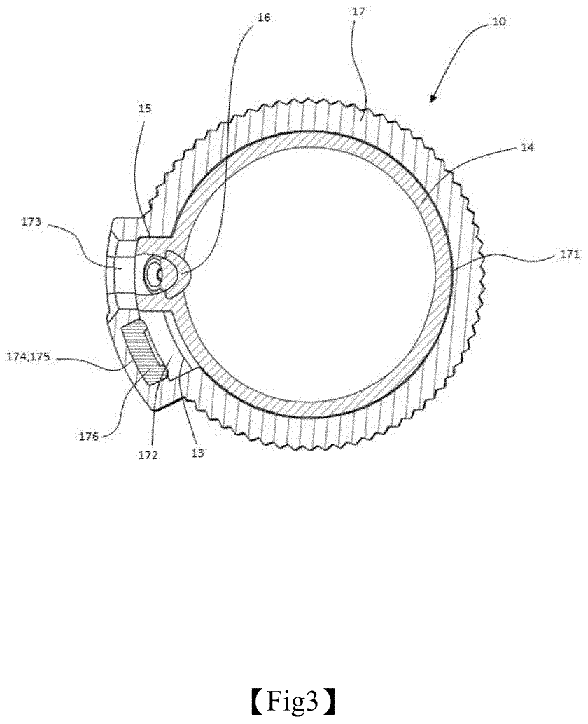

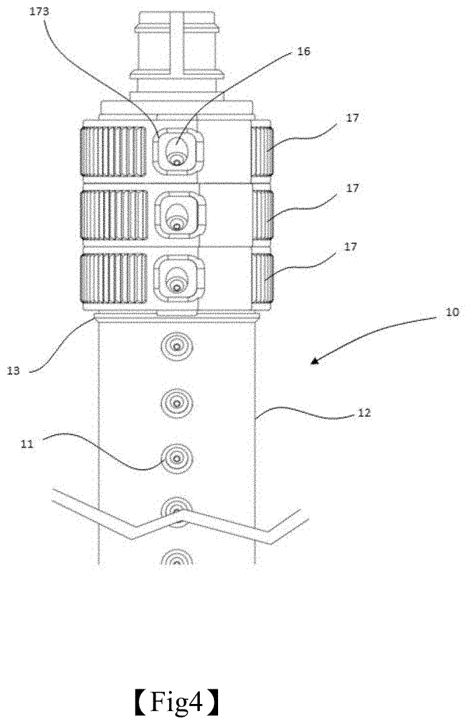

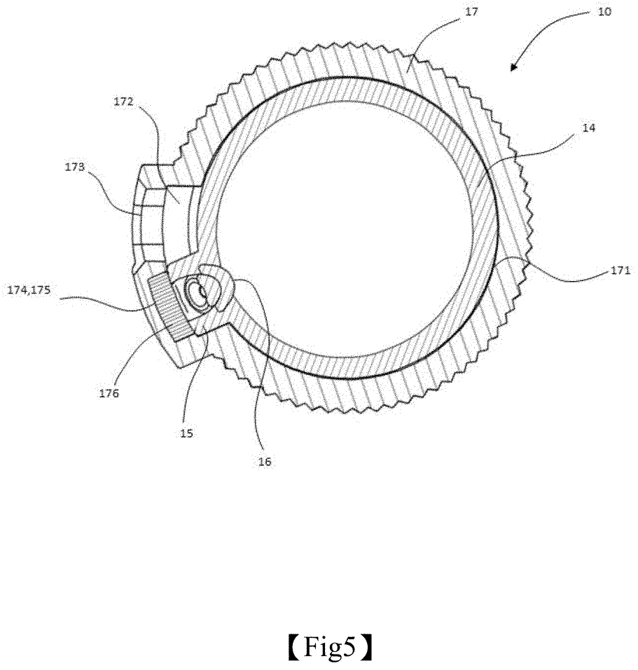

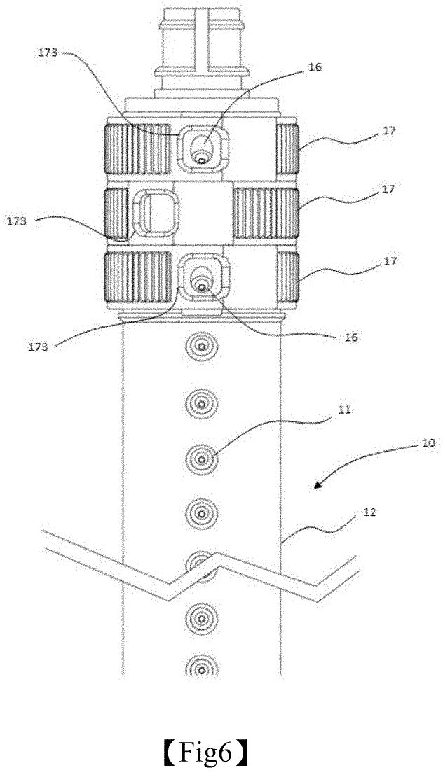

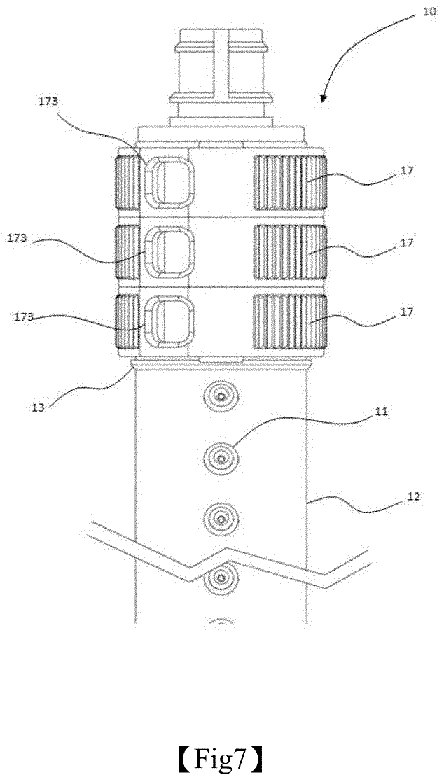

To assemble the sprinkler 10, referring to FIG. 3 and FIG. 4, the adjusting elements 17, which correspond in number to the water outlet openings 16 of the mounting section 14, are mounted as follows. To begin with, the position-limiting space 172 of the first adjusting element 17 is aligned with the position-limiting guide block 15, and then the pivot hole 171 of the first adjusting element 17 is penetrated by the corresponding end of the water outlet tube 12 and subsequently by the mounting section 14 until the first adjusting element 17 reaches the positioning and stopping portion 13. The remaining adjusting elements 17 (i.e., the other two of the three adjusting elements 17 provided in this embodiment to work respectively with the three water outlet openings 16 of the mounting section 14) are mounted sequentially in a similar manner until all the adjusting elements 17 are pivotably positioned around the mounting section 14 and abut against one another, with the position-limiting guide block 15 and the water outlet openings 16 located in the position-limiting spaces 172 of the adjusting elements 17. Each adjusting element 17 can be rotated about and along the mounting section 14 in a certain lateral direction, thereby moving the corresponding position-limiting space 172 along the position-limiting guide block 15 at the same time, and once the adjusting element 17 is blocked by the position-limiting guide block 15, the corresponding through hole 173 is aligned precisely with (and thus renders effective) the corresponding water outlet opening 16, allowing the water in the water outlet tube 12 to be ejected through the corresponding water outlet opening 16 and the corresponding through hole 173. By rotating the adjusting elements 17 in the way described above, the number of the effective water outlet openings 16 of the sprinkler 10 can be increased to supply water to a relatively large area. When it is desired to reduce the number of the effective water outlet openings 16 of the sprinkler 10 (so as to supply water to a relatively small area, for example), each of the adjusting elements 17 (see FIG. 5 and FIG. 6 for the case in which only one adjusting element 17 is involved, and FIG. 7 for the case in which all the adjusting elements 17 are involved) can be rotated in the opposite lateral direction to move the through hole 173 in the corresponding position-limiting space 172 away from the corresponding water outlet opening 16 until the water-blocking pad 176 in the corresponding water-blocking area 174 lies precisely against (and thus blocks) the corresponding water outlet opening 16, thereby keeping the water in the water outlet tube 12 from being ejected through the corresponding through hole 173. To sum up, the sprinkler 10 is so designed that the mounting section 14 (which is provided with the position-limiting guide block 15, the water outlet openings 16, and the positioning and stopping portion 13) can work with the adjusting elements 17 (which have the pivot holes 171, the position-limiting spaces 172, the through holes 173, and the water-blocking areas 174) to enable easy adjustment of the number of the effective water outlet openings 16 and the number of the blocked water outlet openings 16, and that therefore the present invention provides higher flexibility and higher variability in use than achievable in the prior art. Now that the number of the effective or blocked water outlet openings 16 can be easily adjusted according to the size of the area to be sprinkled, insufficient irrigation as well as a wasteful use of water can be prevented.

It can be known from the above that the present invention is both industrially applicable and inventive. Besides, the invention has never been disclosed in any publication and hence meets the novelty requirement. Accordingly, a patent application for the invention is hereby filed according to law in order to be examined.

It should be pointed out that the embodiments described above are only some feasible ones of the present invention and are not intended to be restrictive of the scope of the invention. All equivalent changes and modifications based on the appended claims should fall within the scope of the invention.

What is claimed is:

1. A sprinkler, comprising:
a water outlet tube comprising:
a plurality of water outlet holes;
a positioning and stopping portion provided on at least one lateral side of the water outlet tube, wherein the positioning and stopping portion protrudes from an outer surface of the water outlet tube; and
a mounting section provided on a side of the positioning and stopping portion, wherein the mounting section has a side protrudingly provided with a position-limiting guide block, and the position-limiting guide block has a side provided with at least two water outlet openings in communication with an interior of the water outlet tube to allow water to be output through the water outlet openings; and
at least one adjusting element corresponding in number to the water outlet openings of the mounting section, wherein the adjusting element is annular and comprises:
a pivot hole configured to enable rotation of the adjusting element about and along the mounting section;
a position-limiting space protrudingly provided on a side of the pivot hole to accommodate the position-limiting guide block, wherein the position-limiting space is larger than the position-limiting guide block so as to receive, and be pivotable with respect to, the position-limiting guide block, in order for the position-limiting guide block to limit back-and-forth rotation of the adjusting element; and
a through hole and a water-blocking area, both provided in the position-limiting space and corresponding in position to the water outlet openings, wherein the through hole and the water-blocking area are spaced apart from each other, and the water-blocking area comprises a water-blocking pad;
wherein when the adjusting element is blocked by the position-limiting guide block after rotation in a lateral direction, the through hole in the position-limiting space is aligned precisely with a corresponding one of the water outlet openings to allow water to flow out of the corresponding water outlet opening, thereby rendering the corresponding water outlet opening effective, and when the adjusting element is rotated in an opposite lateral direction such that the through hole is moved away from the corresponding water outlet opening and the water-blocking area lies against the corresponding water outlet opening, the corresponding water outlet opening is blocked; thus, the number of said effective water outlet opening(s) and the number of said blocked water outlet opening(s) of the sprinkler are flexibly and easily adjustable.

2. The sprinkler of claim 1, wherein the positioning and stopping portion surrounds an outer periphery of the water outlet tube.

3. The sprinkler of claim 1, wherein the position-limiting guide block has an elongated and narrow configuration.

4. The sprinkler of claim 1, wherein the position-limiting guide block corresponds in position to the water outlet holes.

5. The sprinkler of claim 1, wherein the water outlet openings of the mounting section are in alignment with the water outlet holes of the water outlet tube.

6. The sprinkler of claim 1, wherein the water-blocking area comprises a groove, and the water-blocking pad is mounted in the groove.
